(19) United States
(12) Patent Application Publication
(10) Pub. No.: US 2014/0185700 A1
(43) Pub. Date: Jul. 3, 2014

(54) METHOD AND APPARATUS FOR LINEAR PRECODING IN MULTI-USER MULTIPLE-INPUT MULTIPLE-OUTPUT SYSTEM

(71) Applicant: Huawei Technologies Co., Ltd., Shenzhen (CN)

(72) Inventors: Mingjie Dong, Shenzhen (CN); Yao Cheng, Shenzhen (CN); Sheng Li, Shenzhen (CN); Florian Roemer, Ilmenau (DE); Jianshu Zhang, Shenzhen (CN); Martin Haardt, Ilmanau (DE)

(73) Assignee: Huawei Technologies Co., Ltd., Shenzhen (CN)

(21) Appl. No.: 14/198,899

(22) Filed: Mar. 6, 2014

Related U.S. Application Data
(63) Continuation of application No. PCT/CN2012/081069, filed on Sep. 6, 2012.

(30) Foreign Application Priority Data
Sep. 6, 2011 (CN) 201110262671.1

(51) Int. Cl. H04B 7/04; H04W 52/42

(52) U.S. Cl. CPC H04B 7/0456; H04B 7/0452; H04W 52/42
USPC 375/267

(57) ABSTRACT

The present invention relates to the field of communications technologies and discloses a method and an apparatus for linear precoding in a multi-user multiple-input multiple-output system, which can reduce computational complexity, improve system efficiency, and enhance system robustness by using a linear precoding technology in the case of imperfect CSI. According to the solutions provided in embodiments of the present invention, a first matrix is determined according to channel information of the system; an equivalent-channel matrix is acquired according to the first matrix; the equivalent-channel matrix is decomposed, and a second matrix is obtained through computation; a precoding matrix is obtained according to the first matrix and the second matrix, so that a power balance is achieved between spatial streams of each user after two signals to be concurrently transmitted are processed by using the precoding matrix.

### CROSS-REFERENCE TO RELATED APPLICATIONS

This application is a continuation of International Application No. PCT/CN2012/081069, filed on Sep. 6, 2012, which claims priority to Chinese Patent Application No. 201110262671.1, filed on Sep. 6, 2011, both of which are hereby incorporated by reference in their entireties.

### TECHNICAL FIELD

The present invention relates to the field of communications technologies, and in particular to a method and an apparatus for linear precoding in a multi-user multiple-input multiple-output system.

### BACKGROUND

On a cellular network, multiple users can concurrently transmit, by using an uplink channel, information to a base station at a same frequency. At this time, the base station may separate signals of different users by using a MUD (Multiple-User Detection, multi-user detection) technology and concurrently transmit signals to the users by using a downlink channel. A part of signals received by each user is MUI (Multi-User Interference, multi-user interference) caused by signals of other users. For the purpose of canceling multi-user interference while considering such user requirements as low power consumption, low complexity, and low costs, the MUI is usually canceled on the base station side.

In the prior art, a BD-GMD (Block Diagonal Geometric Mean Decomposition, block diagonal geometric mean decomposition) technology is used to implement MU MIMO (Multi-User Multiple-Input Multiple-Output, multi-user multiple-input multiple-output) transmission on a single-carrier downlink channel. The BD-GMD is a matrix decomposition method, where an equivalent channel matrix of all end users may firstly be discomposed into three matrices, which are a block diagonal matrix, a lower triangular matrix (diagonal elements of each user are equal in the lower triangular matrix), and a column orthogonal matrix; and then a GMD (Geometric Mean Decomposition, geometric mean decomposition) algorithm is expanded in a recursive manner, so that the BD-GMD technology can be applied in a MU MIMO system.

However, when the BD-GMD technology is used to establish MU MIMO communication, the recursive computation is relatively complex and consumes a lot of signaling overhead during actual signal transmission, which reduces the system efficiency. In addition, the combination of the BD-GMD technology and a non-linear precoding technology is greatly affected by imperfect CSI (channel state information).

### SUMMARY

Embodiments of the present invention provide a method and an apparatus for linear precoding in a multi-user multiple-input multiple-output system, so as to simplify computation and improve system efficiency, as well as to improve system robustness by using a linear precoding technology.

The embodiments of the present invention adopt the following technical solutions:

A method for linear precoding in a multi-user multiple-input multiple-output system, including:
determining a first matrix according to channel information of the system, where the first matrix is used to cancel or suppress multi-user interference;
acquiring an equivalent-channel matrix according to the first matrix, where the equivalent-channel matrix is used to indicate channel information of the system after interference is canceled;
decomposing the equivalent-channel matrix, and obtaining a second matrix through computation, where diagonal elements of matrix blocks corresponding to each user in the second matrix are equal and the second matrix is used to optimize system performance; and
obtaining a precoding matrix according to the first matrix and the second matrix, so that a power balance is achieved between spatial streams of each user after at least two signals to be concurrently transmitted are processed by using the precoding matrix.

An apparatus for linear precoding in a multi-user multiple-input multiple-output system, including:
a determining unit, configured to determine a first matrix according to channel information of the system, where the first matrix is used to cancel or suppress multi-user interference;
a first acquiring unit, configured to acquire an equivalent-channel matrix according to the first matrix, where the equivalent-channel matrix is used to indicate channel information of the system after interference is canceled;
a computing unit, configured to decompose the equivalent-channel matrix and obtain a second matrix through computation, where diagonal elements of matrix blocks corresponding to each user in the second matrix are equal and the second matrix is used to optimize system performance; and
a second acquiring unit, configured to obtain a precoding matrix according to the first matrix and the second matrix, so that a power balance is achieved between spatial streams of each user after at least two signals to be concurrently transmitted are processed by using the precoding matrix.

According to the method and the apparatus for linear precoding in a multi-user multiple-input multiple-output system that are provided in the embodiments of the present invention, a first matrix is determined according to channel information of the system; an equivalent-channel matrix is acquired according to the first matrix; the equivalent-channel matrix is decomposed, and a second matrix is obtained through computation; and a precoding matrix is obtained according to the first matrix and the second matrix. Compared with the prior art where when MU MIMO communication is established by using a BD-GMD technology, recursive computation is relatively complex and the combination of the BD-GMD technology and a non-linear precoding technology is greatly affected by imperfect CSI, the embodiments of the present invention provide solutions that can simplify computation, and improve system robustness by using a linear precoding technology.

### BRIEF DESCRIPTION OF THE DRAWINGS

To illustrate the technical solutions in the embodiments of the present invention more clearly, the following briefly introduces accompanying drawings required for describing the embodiments. Apparently, the accompanying drawings in the following description show merely some embodiments of the present invention, and a person of ordinary skill in the art may still derive other drawings from the accompanying drawings without creative efforts.

FIG. 1 is a flowchart of a method for linear precoding in a multi-user multiple-input multiple-output system according to Embodiment 1 of the present invention;

FIG. 2 is a block diagram of an apparatus for linear precoding in a multi-user multiple-input multiple-output system according to Embodiment 1 of the present invention;

FIG. 3 is a flowchart of a method for linear precoding in a multi-user multiple-input multiple-output system according to Embodiment 2 of the present invention;

FIG. 4 is a schematic diagram of a downlink transmission module of a MU MIMO system according to Embodiment 2 of the present invention; and

FIG. 5 is a block diagram of an apparatus for linear precoding in a multi-user multiple-input multiple-output system according to Embodiment 2 of the present invention.

### DETAILED DESCRIPTION

The following clearly describes the technical solutions in the embodiments of the present invention with reference to the accompanying drawings in the embodiments of the present invention. Apparently, the described embodiments are merely apart rather than all of the embodiments of the present invention. All other embodiments obtained by a person of ordinary skill in the art based on the embodiments of the present invention without creative efforts shall fall within the protection scope of the present invention.

### Embodiment 1

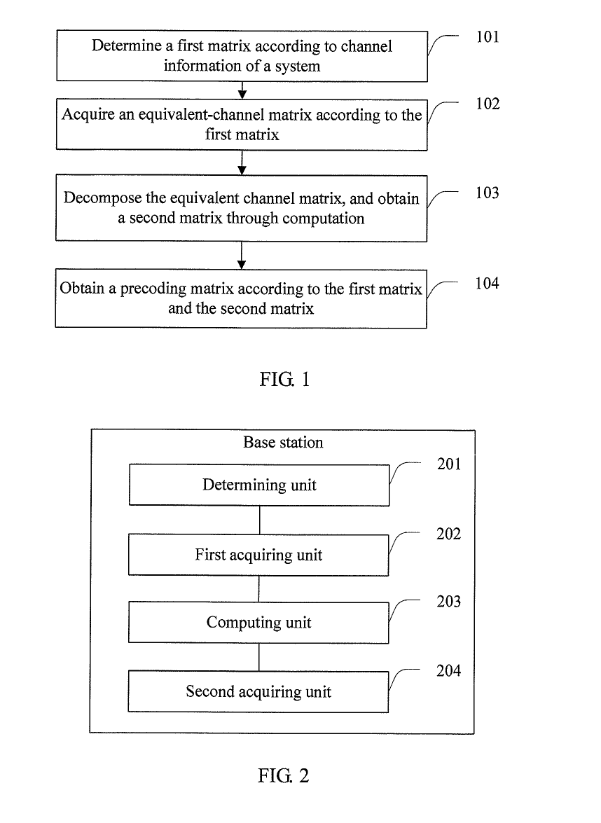

The embodiment of the present invention provides a method for linear precoding in a multi-user multiple-input multiple-output system. As shown in FIG. 1, the method includes:

Step 101: Determine a first matrix according to channel information of the system, where the first matrix is used to cancel or suppress multi-user interference.

Specifically, the first matrix is determined by using a linear closed-loop precoding technology according to channel information of the system.

Step 102: Acquire an equivalent-channel matrix according to the first matrix, where the equivalent-channel matrix is used to indicate channel information of the system after interference is canceled.

Step 103: Decompose the equivalent-channel matrix, and obtain a second matrix through computation, where diagonal elements of matrix blocks corresponding to each user in the second matrix are equal and the second matrix is used to optimize system performance.

Specifically, the second matrix may be computed by using the following two modes:

Mode 1: An equivalent-channel matrix of an i^{th} user is decomposed according to H_{eq,i}=QᵢRᵢPᵢ^{H}, so that diagonal elements in the equivalent-channel matrix of the i^{th} user are equal, and it is obtained through computation that Fᵢ=Pᵢ, where H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}R=I_{L}, where L refers to a rank of a channel matrix H, I refers to a unit matrix, and Fᵢ refers to a second matrix of the i^{th} user; and

F_{b} is obtained according to the method for obtaining Fᵢ, where F_{b} refers to the second matrix.

Mode 2: A power allocation matrix is computed based on a preset matrix, where diagonal elements of matrix blocks corresponding to each user in the preset matrix are diagonal elements in the Rᵢ;
based on a preset diagonal matrix, the equivalent-channel matrix of the i^{th} user is decomposed according to H_{eq,i}=QᵢRᵢPᵢ^{H}, so that diagonal elements in the equivalent-channel matrix of the i^{th} user are equal, and it is obtained through computation that FᵢPᵢG, where diagonal elements of the preset diagonal matrix are the same as those of the Rᵢ and G refers to the power allocation matrix; and

F_{b} is obtained according to the method for obtaining Fᵢ, where F_{b} refers to the second matrix.

Step 104: Obtain a precoding matrix according to the first matrix and the second matrix, so that a power balance is achieved between spatial streams of each user after at least two signals to be concurrently transmitted are processed by using the precoding matrix.

Further, the precoding matrix is obtained according to F=βFₐF_{b}, where F refers to the precoding matrix, β refers to a power control factor, Fₐ refers to the first matrix, and F_{b} refers to the second matrix.

According to the method for linear precoding in a multi-user multiple-input multiple-output system provided in the embodiment of the present invention, a first matrix is determined according to channel information of the system; an equivalent-channel matrix is acquired according to the first matrix; the equivalent-channel matrix is decomposed, and a second matrix is obtained through computation; and a precoding matrix is obtained according to the first matrix and the second matrix. Compared with the prior art where when MU MIMO communication is established by using a BD-GMD technology, recursive computation is relatively complex and the combination of the BD-GMD technology and a non-linear precoding technology is greatly affected by imperfect CSI, the embodiment of the present invention provides a solution that can simplify computation, and improve system robustness by using a linear precoding technology.

The embodiment of the present invention provides an apparatus for linear precoding in a multi-user multiple-input multiple-output system, where the apparatus may specifically be a base station. As shown in FIG. 2, the apparatus includes a determining unit 201, a first acquiring unit 202, a computing unit 203, and a second acquiring unit 204.

The determining unit 201 is configured to determine a first matrix according to channel information of the system, where the first matrix is used to cancel or suppress multi-user interference.

The determining unit 201 is specifically configured to determine, according to the channel information of the system, the first matrix by using a linear closed-loop precoding technology.

The first acquiring unit 202 is configured to acquire an equivalent-channel matrix according to the first matrix, where the equivalent-channel matrix is used to indicate channel information of the system after interference is canceled.

The computing unit 203 is configured to decompose the equivalent-channel matrix and obtain a second matrix through computation, where diagonal elements of matrix blocks corresponding to each user in the second matrix are equal and the second matrix is used to optimize system performance.

A first computing module of the computing unit 203 is configured to decompose an equivalent-channel matrix of an i^{th} user according to H_{eq,i}=QᵢRᵢPᵢ^{H}, so that diagonal elements in the equivalent-channel matrix of the i^{th} user are equal, and obtain through computation that Fᵢ=Pᵢ, where H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}P=I_{L}, where L refers to a rank of a channel matrix H, I refers to a unit matrix, and Fᵢ refers to a second matrix of the i^{th} user.

The first computing module is further configured to obtain F_{b} according to the method for obtaining Fᵢ, where F_{b} refers to the second matrix.

A second computing module of the computing unit 203 is configured to compute a power allocation matrix based on a preset matrix, where diagonal elements of matrix blocks corresponding to each user in the preset matrix are diagonal elements in the Rᵢ.

A third computing module is configured to decompose, based on a preset diagonal matrix, the equivalent-channel matrix of the i^{th} user according to H_{eq,i}=QᵢRᵢPᵢ^{H}, so that diagonal elements in the equivalent-channel matrix of the i^{th} user are equal, and obtain through computation that Fᵢ=PᵢG, where diagonal elements of the preset diagonal matrix are the same as those of the Rᵢ and G refers to the power allocation matrix.

The third computing module is further configured to obtain F_{b} according to the method for obtaining Fᵢ, where F_{b} refers to the second matrix.

The second acquiring unit 204 is configured to obtain a precoding matrix according to the first matrix and the second matrix, so that a power balance is achieved between spatial streams of each user after at least two signals to be concurrently transmitted are processed by using the precoding matrix.

The second acquiring unit is specifically configured to obtain the precoding matrix according to F=βFₐF_{b}, where F refers to the precoding matrix, β refers to a power control factor, Fₐ refers to the first matrix, and F_{b} refers to the second matrix.

According to the apparatus for linear precoding in a multi-user multiple-input multiple-output system provided in the embodiment of the present invention, a determining unit determines a first matrix according to channel information of the system; a first acquiring unit acquires an equivalent-channel matrix according to the first matrix; a computing unit decomposes the equivalent-channel matrix and obtains a second matrix through computation; and a second acquiring unit obtains a precoding matrix according to the first matrix and the second matrix. Compared with the prior art where when MU MIMO communication is established by using a BD-GMD technology, recursive computation is relatively complex and the combination of the BD-GMD technology and a non-linear precoding technology is greatly affected by imperfect CSI, the embodiment of the present invention provides a solution that can simplify computation, and improve system robustness by using a linear precoding technology.

### Embodiment 2

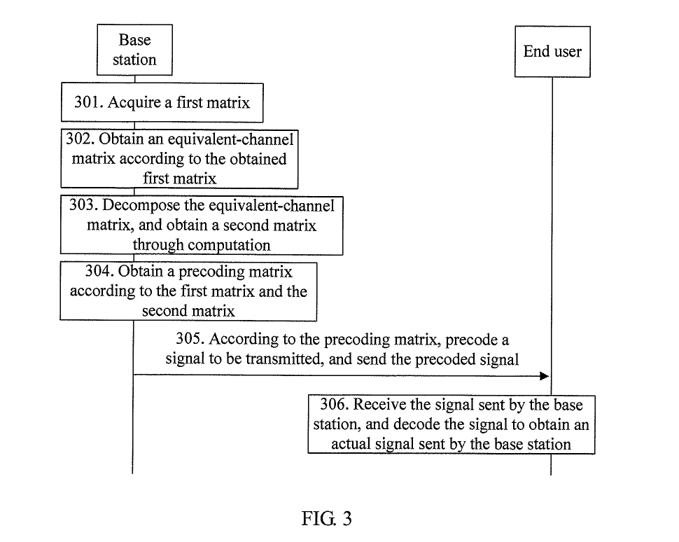

The embodiment of the present invention provides a method for linear precoding in a multi-user multiple-input multiple-output system. As shown in FIG. 3, the method includes:

Step 301: Abase station determines a first matrix according to channel information of the system, where the first matrix is used to cancel or suppress multi-user interference.

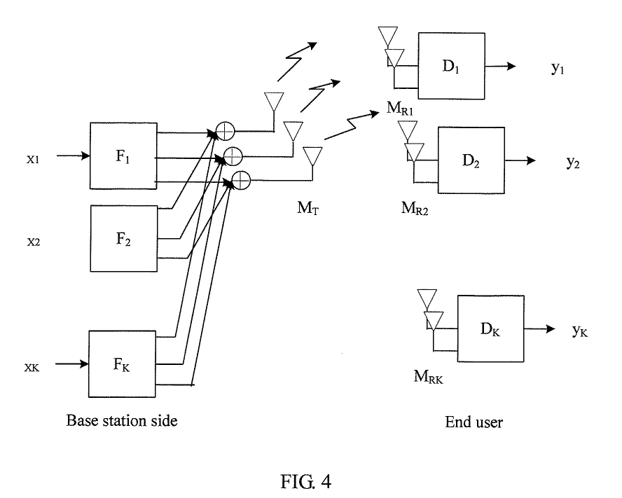

It should be noted that a downlink transmission module of a MU MIMO system is illustrated in FIG. 4. The downlink transmission module of the MU MIMO system includes a base station side and a user side. Firstly, on the base station side, there are M_{T} installed transmit antennas, K users, M_{R}_{ᵢ} receive antennas for each user, where i=1, 2, . . . , K. A transmitted signal of an i^{th} user is defined as an rᵢ-dimensional vector xᵢ, where rᵢ refers to the number of data streams sent to the i^{th} user. K vectors may be expressed as follows:

$$x = [ \begin{matrix}{x}_{1}^{T} & {x}_{2}^{T} & … & {x}_{K}^{T}\end{matrix} ] , \\ x ∈ {□}^{rx 1} , \\ where$$

$$r = {\sum }_{i = 1}^{K} {r}_{i} .$$

A joint precoding matrix may be expressed as F=[F₁ F₂ . . . F_{K}], Fε^{M}^{_{T}}^{×r}, where Fᵢε□^{M}^{_{T×r i}} refers to a precoding matrix of the i^{th} user.

It is assumed that under the condition of OFDM (Orthogonal Frequency-Division Multiplexing, orthogonal frequency-division multiplexing) transmission, a given frequency and a given time, the channel matrix of the i^{th} user is expressed as Hᵢ,

$${H}_{i} ∈ {•}^{{M}_{{R}_{i}} \times {M}_{T}} ,$$

and the joint channel matrix of the K users is expressed as follows: H=[H₁^{T} H₂^{T}, . . . H_{K}^{T}]^{T}, Hε□^{M}^{_{R}}^{×M}^{_{T}}.

On the user side, a decoding matrix is used for received signals. A joint block diagonal decoding matrix may be expressed as follows:

$$D = [ \begin{matrix}{D}_{1} & 0 & … & 0 \\ 0 & {D}_{2} & … & ⋮ \\ ⋮ & ⋮ & ⋱ & ⋮ \\ 0 & 0 & … & {D}_{K}\end{matrix} ] , \\ D ∈ {□}^{r \times {M}_{R}} .$$

Therefore, a joint receive vector may be expressed as follows:

y=D·(H·F·x+n), where y=[y₁^{T} y₂^{T} . . . y_{K}^{T}]^{T}, yε□^{r×1}, yᵢε□^{r}^{ᵢ}^{×1}, yᵢ refers to a receive vector of the user, and n=[n₁^{T} n₂^{T} . . . n_{K}^{T}]^{T}, nε□^{M}^{ₙ}^{×1}, where n refers to zero-mean additive white Gaussian noise on a receive antenna.

Further, the base station determines, according to the channel information of the system, the first matrix by using a linear closed-loop precoding technology. Specifically, computation may be performed by using a linear closed-loop precoding technology in the prior art. Specific description is as follows:

Mode 1: A joint channel matrix \tilde{H}ᵢ of other users than the channel of the i^{th} user is defined, where \tilde{H}ᵢ=[H₁^{T} . . . Hᵢ₋₁^{T} Hᵢ₊₁^{T} . . . H_{K}^{T}]^{T}. According to a multi-user zero interference restriction, the precoding matrix of the i^{th} user is located in a null space of the \tilde{H}ᵢ matrix, where the null space may be an orthogonal space.

Therefore, by using an SVD (Singular value decomposition, singular value decomposition) technology and based on MUI (Multi-User Interference, multi-user interference) cancellation or suppression, that is, \tilde{H}ⱼFₐ_{ᵢ}=0, j≠I, j, i=1, 2, . . . k, the \tilde{H}ᵢ with a rank of \tilde{L}ᵢ is decomposed into the following form:

$${\tilde{H}}_{i} = {\tilde{U}}_{i} {\sum }_{i}^{\sim} {[ \begin{matrix}{\tilde{V}}_{i}^{( 1 )} & {\tilde{V}}_{i}^{( 0 )}\end{matrix} ]}^{H}$$

so that Fₐ_{ᵢ}=\tilde{V}ᵢ⁽⁰⁾ may be obtained,
where \tilde{V}ᵢ⁽⁰⁾ refers to the first \tilde{L}ᵢ right singular vectors (right singular vectors), and \tilde{V}ᵢ⁽⁰⁾ refers to the last (M_{T}−\tilde{L}ᵢ) right singular vectors. These right singular vectors form an orthogonal base of a left null space of the \tilde{H}ᵢ, and Fₐ_{ᵢ} refers to the first matrix of the i^{th} user.

According to the method for obtaining Fₐ_{ᵢ}, SVD is performed for K times; that is, the first matrix of other users is re-computed. In this way, the first matrix Fₐ can be obtained.

Mode 2: A joint channel matrix \tilde{H}ᵢ of other users than the channel of the i^{th} user is defined, where \tilde{H}ᵢ=[H₁^{T} . . . Hᵢ₋₁^{T} Hᵢ₊₁^{T} . . . H_{K}^{T}]^{T}.

The equivalent joint channel matrix of all users is expressed as

$${HF}_{a} = [ \begin{matrix}{H}_{1} {F}_{{a}_{1}} & {H}_{1} {F}_{{a}_{2}} & … & {H}_{1} {F}_{{a}_{K}} \\ {H}_{2} {F}_{{a}_{1}} & {H}_{2} {F}_{{a}_{2}} & … & {H}_{2} {F}_{{a}_{K}} \\ ⋮ & ⋮ & ⋱ & ⋮ \\ {H}_{K} {F}_{{a}_{1}} & {H}_{K} {F}_{{a}_{2}} & … & {H}_{K} {F}_{{a}_{K}}\end{matrix} ] ,$$

where the equivalent-channel matrix of the i^{th} user is HᵢFₐ_{ᵢ}. Interference caused by other users to the i^{th} user is determined by using the \tilde{H}ᵢFₐ_{ᵢ}.

In areas with a high SNR (Signal-to-Noise Ratio, signal-to-noise ratio), non-diagonal blocks of the equivalent joint channel matrix HFₐ of all users are converged to zero, that is, \tilde{H}ⱼFₐ_{ᵢ}=0 j≠i, j, i=1, 2, . . . , k. Therefore, an SVD is performed on the \tilde{H}ᵢ, that is, \tilde{H}ᵢ=Ũᵢ\tilde{Σ}ᵢ\tilde{V}ᵢ, and it may be obtained through computation that:

$${F}_{{a}_{i}} = \tilde{V} {i ( {\sum }_{1}^{{\sim}^{T}} {\sum }_{i}^{\sim} + \frac{{M}_{R} {σ}_{n}^{2}}{{P}_{T}} {I}_{Mr} )}^{- 1 \text{/} 2} ;$$

where, P_{T} refers to transmit power allocated to each subcarrier, and σₙ² refers to noise power of a receiver on each subcarrier bandwidth. Each subcarrier uses an equal-power allocation scheme, that is,

$${P}_{T} = \frac{{P}_{T , tot}}{{N}_{SD}} ,$$

where P_{T,lot} refers to the total transmit power and N_{SD} refers to the number of data subcarriers.

SVD is performed for K times according to the method for obtaining Fₐ_{ᵢ}; that is, the first matrix of other users is re-computed. In this way, the first matrix Fₐ can be obtained.

According to the first matrix obtained by using the method in Mode 2, a power balance may be achieved between multiple spatial streams of each user.

It should be noted that, under the precondition that CSI is obtained by the base station side, multi-user interference may be canceled by using a linear precoding technology and a non-linear precoding technology. Compared with the non-linear precoding technology, the linear precoding technology has lower computational complexity and higher robustness in a case where the CSI is imperfect. Therefore, in the solution provided in the embodiment of the present invention, the linear precoding technology is used to cancel multi-user interference.

Step 302: The base station obtains an equivalent-channel matrix according to the obtained first matrix, where the equivalent-channel matrix is used to indicate channel information of the system after interference is canceled.

When a precoded signal is sent to a user through a channel, the signal is changed. Factors that cause such a change are precoding as well as signal attenuation and interference signals added during signal transmission on the channel. At this time, such a signal change may be considered to be completely caused by the channel, and the channel is an equivalent channel; that is, the equivalent-channel matrix is used to indicate channel information of the system after interference is canceled. Processing the signal by using the equivalent channel matrix may enable multiple spatial streams to use a same modulation and coding scheme.

As the obtained first matrix may be used to cancel or suppress multi-user interference, that is, \tilde{H}ⱼFₐ_{ᵢ}=0, j≠i, j, i=1, 2, . . . , k, an equivalent-channel matrix H_{eq,i}=Hᵢ\tilde{V}ᵢ⁽⁰⁾ of the i^{th} user may be obtained. The dimension of the channel matrix is equivalent to the dimension of an (M_{T}−\tilde{L}ᵢ)×M_{R}_{ᵢ}-dimensional single-user MIMO system, where (M_{T}−\tilde{L}ᵢ) refers to the number of transmit antennas and M_{R}_{ᵢ} refers to the number of receive antennas.

Step 303: The base station decomposes the equivalent-channel matrix and obtains a second matrix through computation, where diagonal elements of matrix blocks corresponding to each user in the second matrix are equal and the second matrix is used to optimize system performance.

After the multi-user interference is canceled, each equivalent single-user MIMO channel H_{eq,i}, where K i=1, 2, . . . , K, has a same attribute as a traditional single-user MIMO channel. According to standard IEEE 802.11ac specifications, the number of spatial streams on all subcarriers must be the same in a transmission process for transmitting multi-user information packets. Therefore, in the prior art, a precoding matrix is computed for each subcarrier by using a water-filling algorithm, and the number of spatial streams of a user on a certain subcarrier may change. This may lead to difference in the number of spatial streams on all subcarriers.

In single-user MIMO transmission, the combination of GMD (geometric mean decomposition, geometric mean decomposition) and SIC (successive interference cancellation, successive interference cancellation) is capable of decomposing an MIMO channel into multiple parallel sub-channels with the same SINR (Signal-to-Interference-plus-Noise Ratio, signal-to-interference-plus-noise ratio). Specifically, anyone of the following modes may be used:

Mode 1:

The GMD decomposition of a channel matrix H is defined as H=Q□R□P^{H}, where a rank of the channel matrix H is L, the non-zero singular value is λₙ, n=1, 2, . . . , L, and Hε□^{M}^{_{R}}^{M}^{ᵣ}; Rε□^{L×L} is an upper triangular matrix, and the element R_{i,j} in a matrix R satisfies i>j and rᵢⱼ=0, for 1≦i≦L,

$${r}_{ii} = \overline{λ} □ {( {\prod }_{n = 1}^{L} {λ}_{n} )}^{1 \text{/} L} ,$$

and diagonal elements of the matrix R are the same, where λ̅ refers to a geometric mean value of the non-zero singular value λₙ of the matrix H; and matrices Qε□^{M}^{_{R}}^{×L}, Pε□^{M}^{_{T}}^{×L}, and Q and P satisfy Q^{H}Q=P^{H}P=I_{L}.

The equivalent-channel matrix of the i^{th} user is decomposed by using the GMD, that is, the equivalent-channel matrix of the i^{th} user is decomposed according to H_{eq, i}=QᵢRᵢPᵢ^{H}, so that diagonal elements in the equivalent-channel matrix of the i^{th} user are equal, and it is obtained through computation that Fᵢ=Pᵢ, where H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}P=I_{L}, where L refers to the rank of the channel matrix H, I refers to a unit matrix, and Fᵢ refers to a second matrix of the i^{th} user.

According to the method for obtaining Fᵢ, GMD decomposition is performed on equivalent channels of K users for K times so as to obtain F_{b}, where F_{b} refers to the second matrix and diagonal elements of matrix blocks corresponding to each user in the second matrix are equal.

Mode 2: With respect to mode 2 in the method for obtaining the first matrix, power control may be performed by using an MMSE (Minimum Mean-Square-Error, minimum mean-square-error) power allocation scheme. Because the BER (Bit Error Rate, bit error rate) performance of the entire system is restricted by the performance of a user with the highest BER, the system may allocate more power to such a user to balance the BER of the system. Therefore, power efficiency can be further improved by using the following modes to obtain F_{b}:

(1) A power allocation matrix is computed based on a preset matrix.

The preset matrix is Σₑ:

$${\sum }_{e}^{ } = [ \begin{matrix}{R}_{diag , 1} & 0 & … & 0 \\ 0 & {R}_{diag , 2} & … & 0 \\ ⋮ & ⋮ & ⋱ & ⋮ \\ 0 & 0 & … & {R}_{diag , K}\end{matrix} ] , \\ {\sum }_{e}^{ } ∈ {□}^{r \times r}$$

Then, the power allocation matrix is computed according to

$$G = {( {\sum }_{e}^{T} {\sum }_{e}^{ } \frac{{M}_{R} {σ}_{n}^{2}}{{P}_{T}} {I}_{r} )}^{- 1} {\sum }_{e}^{T} .$$

G refers to the power allocation matrix; Σₑ refers to the preset matrix, and diagonal elements of matrix blocks corresponding to each user in the Σₑ are diagonal elements in the Rᵢ; R_{diag,1} refers to a matrix block corresponding to a first user, and diagonal elements in the R_{diag,1} are the same as those in the Rᵢ; P_{T} refers to transmit power allocated to each subcarrier; σₙ² refers to noise power of a receiver on each subcarrier bandwidth, and each subcarrier uses an equal-power allocation scheme,

that is,

$${P}_{T} = \frac{{P}_{T , tot}}{{N}_{SD}} ,$$

where P_{T, tot} refers to the total transmit power, and N_{SD} refers to the number of data subcarriers.

(2) Based on a preset diagonal matrix, the equivalent-channel matrix of the i^{th} user is decomposed for the i^{th} user according to H_{eq, i}=QᵢRᵢPᵢ^{H}, so that diagonal elements in the equivalent-channel matrix of the i^{th} user are equal, and it is obtained through computation that Fᵢ=PᵢG, where diagonal elements of the preset diagonal matrix are the same as those of the Rᵢ, and G refers to the power allocation matrix.

A diagonal matrix R_{diag,i}ε□^{r}^{ᵢ}^{×r}^{ⱼ} is defined for the i^{th} user, and diagonal elements in the diagonal matrix are the same as those of the Rᵢ.

(3) According to the method for obtaining Fᵢ, that is, according to (1) and (2), GMD is performed on equivalent channels of K users for K times so as to obtain F_{b}, where F_{b} refers to the second matrix and diagonal elements of matrix blocks corresponding to each user in the second matrix are equal.

Specifically,

$${F}_{b} = [ \begin{matrix}{P}_{1} & 0 & … & 0 \\ 0 & {P}_{2} & … & 0 \\ ⋮ & ⋮ & ⋱ & ⋮ \\ 0 & 0 & … & {P}_{K}\end{matrix} ] □ G , {F}_{b } ∈ {□}^{Mx \times R} ,$$

where

$${M}_{x} = {\sum }_{i = 1}^{K} {M}_{{x}_{i}} , {M}_{{x}_{i}} \leq r ,$$

Mₓ refers to the total number of antennas at a receive end, and r refers to the total number of spatial streams on the base station side.

Step 304: The base station obtains a precoding matrix according to the first matrix and the second matrix, so that a power balance is achieved between spatial streams of each user after at least two signals to be concurrently transmitted are processed by using the precoding matrix.

Further, the precoding matrix is obtained according to F=βFₐF_{b}, where F refers to the precoding matrix, β refers to a power control factor, Fₐ refers to the first matrix, and F_{b} refers to the second matrix.

After at least two signals to be concurrently transmitted are processed by using the precoding matrix, a power balance is achieved between spatial streams of each user. This may ensure that multiple spatial streams use the same modulation and coding mode, so that the solution provided in the embodiment of the present invention is applicable to an IEEE (Institute of Electrical and Electronics Engineers, Institute of Electrical and Electronics Engineers) 802.11ac MU MIMO system.

It should be noted that step 301 to step 304 are computation performed on the base station side. In addition, according to a BD-GMD technology in the prior art, recursive computation is mainly used, and this computation has rather high computational complexity; in the solution provided in the embodiment of the present invention, the computation amount is mainly generated from the computation of the first matrix and the second matrix. The computation of the first matrix depends on the used multi-user interference cancellation or suppression scheme, so that the first matrix is located in a universal left null space of other users' channel matrices. In this way, the computational complexity is that SVD needs to be performed for K times. When the second matrix is computed, GMD needs to be performed on equivalent channels of users for K times. Therefore, compared with the computational complexity in the prior art, the computational complexity in the solution provided in the embodiment of the present invention is obviously reduced.

Step 305: According to the precoding matrix, the base station precodes a signal to be transmitted and sends the precoded signal to an end user.

Step 306: The end user receives the signal sent by the base station, and decodes the signal to obtain an actual signal sent by the base station.

A decoding matrix is used for the received signal. A joint block diagonal decoding matrix may be expressed as follows:

$$D = [ \begin{matrix}{D}_{1} & 0 & … & 0 \\ 0 & {D}_{2} & … & ⋮ \\ ⋮ & ⋮ & ⋱ & ⋮ \\ 0 & 0 & … & {D}_{K}\end{matrix} ] , \\ D ∈ {□}^{r \times {M}_{R}} .$$

Therefore, a joint receive vector may be expressed as follows:

y=D·(H·F·x+n), where y=[y₁^{T}y₂^{T} . . . y_{K}^{T}]^{T}, yε□^{r×1}, yᵢε□^{r}^{ᵢ}^{×1}, yᵢ refers to a receive vector of the i^{th} user, and n=[n₁^{T} n₂^{T} . . . n_{K}^{T}]^{T}, nε□^{M}^{_{R}}^{×1}, where n refers to zero-mean additive white Gaussian noise on a receive antenna.

If F is replaced by Fₐ and F_{b},

$$( \begin{matrix}{y}_{1} \\ {y}_{2} \\ ⋮ \\ {y}_{K}\end{matrix} ) = [ \begin{matrix}{D}_{1} & 0 & … & 0 \\ 0 & {D}_{2} & … & ⋮ \\ ⋮ & ⋮ & ⋱ & ⋮ \\ 0 & 0 & … & {D}_{K}\end{matrix} ] □ ( [ \begin{matrix}{H}_{1} \\ {H}_{2} \\ ⋮ \\ {H}_{K}\end{matrix} ] □ β □ [ \begin{matrix}{F}_{{a}_{1}} & {F}_{{a}_{2}} & … & {F}_{{a}_{K}}\end{matrix} ] □ [ \begin{matrix}{F}_{{b}_{1}} & 0 & … & 0 \\ 0 & {F}_{{b}_{2}} & … & 0 \\ ⋮ & ⋮ & ⋱ & ⋮ \\ 0 & 0 & … & {F}_{{b}_{K}}\end{matrix} ] □ [ \begin{matrix}{x}_{1} \\ {x}_{2} \\ ⋮ \\ {x}_{K}\end{matrix} ] + [ \begin{matrix}{n}_{1} \\ {n}_{2} \\ ⋮ \\ {n}_{K}\end{matrix} ] )$$

After the multi-user interference is canceled, \tilde{H}ⱼFₐ_{ᵢ}=0. Therefore, further,

$$( \begin{matrix}{y}_{1} \\ {y}_{2} \\ ⋮ \\ {y}_{K}\end{matrix} ) = [ \begin{matrix}{D}_{1} & 0 & … & 0 \\ 0 & {D}_{2} & … & ⋮ \\ ⋮ & ⋮ & ⋱ & ⋮ \\ 0 & 0 & … & {D}_{K}\end{matrix} ] □ ( [ \begin{matrix}{H}_{1} {F}_{{a}_{1}} & 0 & … & 0 \\ 0 & {H}_{2} {F}_{{a}_{2}} & … & 0 \\ ⋮ & ⋮ & ⋱ & ⋮ \\ 0 & 0 & … & {H}_{K} {F}_{{a}_{K}}\end{matrix} ] □ [ \begin{matrix}β {F}_{{b}_{1}} & 0 & … & 0 \\ 0 & β {F}_{{b}_{2}} & … & 0 \\ ⋮ & ⋮ & ⋱ & ⋮ \\ 0 & 0 & … & β {F}_{{b}_{K}}\end{matrix} ] □ [ \begin{matrix}{x}_{1} \\ {x}_{2} \\ ⋮ \\ {x}_{K}\end{matrix} ] + [ \begin{matrix}{n}_{1} \\ {n}_{2} \\ ⋮ \\ {n}_{K}\end{matrix} ] )$$

It should be noted that, on the base station side, the decoding matrix is fed back to the end user by using a feedback mechanism. Specifically, on the end user side, a SIC receiver may be used to receive a signal. In this way, the decoding matrix Dᵢ of the i^{th} user is Qᵢ^{H}, and after the obtained first matrix and second matrix are substituted into the formula, the signal received by the end user is y=β·R·x+n_{eq}.

In addition, if no feedback mechanism is available in a communications link to feed back the decoding matrix to the end user, an MMSE receiver may be used. In this way, the signal received by the end user is y=β·D·H·Fₐ·F_{b}x+D·n_{eq}, where,

$${D}_{i} = {( {H}_{i} {F}_{i} {F}_{i}^{H} {H}_{i}^{H} + {σ}_{n}^{2} {I}_{{M}_{{R}_{i}}} )}^{- 1} {H}_{i} {F}_{i} .$$

For example, the maximum number of spatial streams is equal to 8 during emulations; when four users (each having two spatial streams) are served concurrently, optimal performance can be obtained.

According to the method for linear precoding in a multi-user multiple-input multiple-output system provided in the embodiment of the present invention, a first matrix is determined according to channel information of the system; an equivalent-channel matrix is acquired according to the first matrix; the equivalent-channel matrix is decomposed, and a second matrix is obtained through computation; and a precoding matrix is obtained according to the first matrix and the second matrix. Compared with the prior art where when MU MIMO communication is established by using a BD-GMD technology, recursive computation is relatively complex and the combination of the BD-GMD technology and a non-linear precoding technology is greatly affected by imperfect CSI, the embodiment of the present invention provides a solution that can simplify computation, and improve system robustness by using a linear precoding technology.

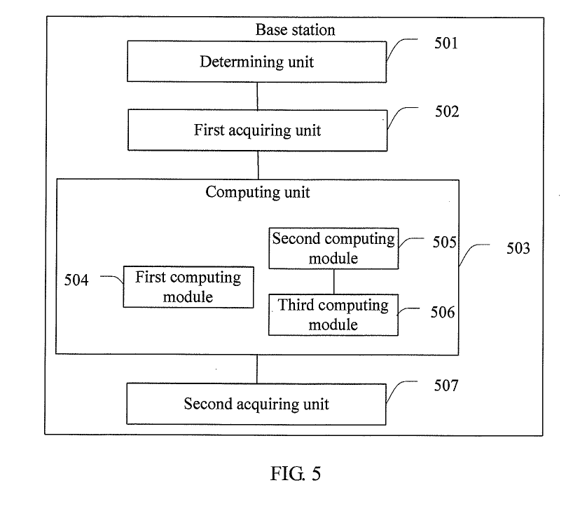

The embodiment of the present invention provides an apparatus for linear precoding in a multi-user multiple-input multiple-output system, where the apparatus may be a base station. As shown in FIG. 5, the apparatus includes a determining unit 501, a first acquiring unit 502, a computing unit 503, a first computing module 504, a second computing module 505, a third computing module 506, and a second acquiring unit 507.

The determining unit 501 is configured to determine a first matrix according to channel information of the system, where the first matrix is used to cancel or suppress multi-user interference. Specifically, the determining unit 501 determines, according to the channel information of the system, the first matrix by using a linear closed-loop precoding technology, where the linear closed-loop precoding technology may be any linear precoding technology in the prior art.

It should be noted that, under the precondition that CSI is obtained by the base station side, multi-user interference may be canceled by using a linear precoding technology and a non-linear precoding technology. Compared with the non-linear precoding technology, the linear precoding technology has lower computational complexity and higher robustness in a case where the CSI is imperfect. Therefore, in the solution provided in the embodiment of the present invention, the linear precoding technology is used to cancel multi-user interference.

The first acquiring unit 502 acquires an equivalent-channel matrix according to the acquired first matrix, where the equivalent-channel matrix is used to indicate channel information of the system after interference is canceled.

When a precoded signal is sent to a user through a channel, the signal is changed. Factors that cause such a change are precoding as well as signal attenuation and interference signals added during signal transmission on the channel. At this time, the signal change may be considered to be completely caused by the channel, and the channel is an equivalent channel.

The computing unit 503 decomposes the equivalent-channel matrix and obtains a second matrix through computation, where diagonal elements of matrix blocks corresponding to each user in the second matrix are equal and the second matrix is used to optimize system performance.

Specifically, the first computing module 504 of the computing unit 503 decomposes an equivalent-channel matrix of an i^{th} user according to H_{eq,i}=QᵢRᵢPᵢ^{H}, so that diagonal elements in the equivalent-channel matrix of the i^{th} user are equal, and obtains through computation that Fᵢ=Pᵢ, where H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}P=I_{L}, where L refers to a rank of a channel matrix H, I refers to a unit matrix, and Fᵢ refers to a second matrix of the i^{th} user.

The first computing module 504 is further configured to obtain F_{b} according to the method for obtaining Fᵢ, where F_{b} refers to the second matrix and diagonal elements of matrix blocks corresponding to each user in the second matrix are equal. Specifically, according to the method for obtaining Fᵢ, GMD decomposition is performed on equivalent channels of K users for K times, so that the second matrix may be obtained.

In addition, based on a preset matrix, the second computing module 505 of the computing unit 503 computes a power allocation matrix, where the preset matrix is Σₑ:

$${\sum }_{e} = [ \begin{matrix}{R}_{diag , 1} & 0 & … & 0 \\ 0 & {R}_{diag , 2} & … & 0 \\ ⋮ & ⋮ & ⋱ & ⋮ \\ 0 & 0 & … & {R}_{diag , K}\end{matrix} ] , {\sum }_{e} ∈ {□}^{r \times r}$$

The second computing module 505 is specifically configured to compute the power allocation matrix according to

where G refers to the power allocation matrix;

$$G = {( {\sum }_{e}^{T} {\sum }_{e}^{ } + \frac{{M}_{R} {σ}_{n}^{2}}{{P}_{T}} {I}_{r} )}^{- 1} {\sum }_{e}^{T} ,$$

Σₑ refers to the preset matrix; diagonal elements of matrix blocks corresponding to each user in the Σₑ are diagonal elements in the Rᵢ; R_{diag,1} refers to a matrix block corresponding to a first user, and diagonal elements in the R_{diag,1} are the same as those in the R₁; P_{T} refers to transmit power allocated to each subcarrier; and σₙ² refers to noise power of a receiver on each subcarrier bandwidth.

Based on a preset diagonal matrix, the third computing module 506 decomposes the equivalent-channel matrix of the i^{th} user according to H_{eq,i}=QᵢRᵢPᵢ^{H}, so that diagonal elements in the equivalent-channel matrix of the i^{th} user are equal, and obtains through computation that Fᵢ=PᵢG, where diagonal elements of the preset diagonal matrix are the same as those of the Rᵢ, and G refers to the power allocation matrix.

The third computing module 506 is further configured to obtain F_{b} according to the method for obtaining Fᵢ, where F_{b} refers to the second matrix.

After the first matrix and the second matrix are obtained, the second acquiring unit 507 obtains a precoding matrix according to the first matrix and the second matrix, so that a power balance is achieved between spatial streams of each user after at least two signals to be concurrently transmitted are processed by using the precoding matrix.

Further, the second acquiring unit 507 is specifically configured to obtain the precoding matrix according to F=βFₐF_{b}, where F refers to the precoding matrix, β refers to a power control factor, Fₐ refers to the first matrix, and F_{b} refers to the second matrix.

After at least two signals to be concurrently transmitted are processed by using the precoding matrix, a power balance is achieved between spatial streams of each user. This may ensure that multiple spatial streams use the same modulation and coding mode, so that the solution provided in the embodiment of the present invention is applicable to an IEEE 802.11ac MU MIMO system. After a coded signal is sent to an end user, the end user may decode the received signal by using a decoding matrix. Specifically, the end user may use a SIC receiver or an MMSE receiver to receive the signal.

According to the apparatus for linear precoding in a multi-user multiple-input multiple-output system provided in the embodiment of the present invention, a determining unit determines a first matrix according to channel information of the system; a first acquiring unit acquires an equivalent-channel matrix according to the first matrix; a computing unit decomposes the equivalent-channel matrix and obtains a second matrix through computation; and a second acquiring unit obtains a precoding matrix according to the first matrix and the second matrix. Compared with the prior art where when MU MIMO communication is established by using a BD-GMD technology, recursive computation is relatively complex and the combination of the BD-GMD technology and a non-linear precoding technology is greatly affected by imperfect CSI, the embodiment of the present invention provides a solution that can simplify computation, and improve system robustness by using a linear precoding technology.

It should be noted that the solutions provided in the embodiments of the present invention can be extensively applied in uplink transmission of a MU MIMO system. In a downlink transmission process, precoding processing is mainly performed on data to ensure that multi-user interference on the user terminal is canceled or suppressed. In uplink transmission of a MU MIMO system, a group of users concurrently transmit information to a base station at a same frequency, some downlink gains may also be obtained, and multiple antennas using a distributed antenna array may be effectively utilized. The concurrent transmission is different from the downlink transmission mainly in that: antennas between multiple users cannot work cooperatively. In an uplink transmission process, to ensure low terminal costs and a possibly simple pre-processing process, post-processing on the base station side needs to resist interference between end users. In this way, the solutions provided in the embodiments of the present invention may be inversely applied in the uplink.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for linear precoding in a multi-user multiple-input multiple-output system, the method comprising:
determining a first matrix according to channel information of the system, wherein the first matrix is used to cancel or suppress multi-user interference;
acquiring an equivalent-channel matrix according to the first matrix, wherein the equivalent-channel matrix is used to indicate channel information of the system after interference is canceled;
decomposing the equivalent-channel matrix, and obtaining a second matrix through computation, wherein diagonal elements of matrix blocks corresponding to each user in the second matrix are equal and the second matrix is used to optimize system performance; and
obtaining a precoding matrix according to the first matrix and the second matrix, so that a power balance is achieved between spatial streams of each user after at least two signals to be concurrently transmitted are processed by using the precoding matrix.

2. The method for linear precoding in a multi-user multiple-input multiple-output system according to claim 1, wherein determining a first matrix according to channel information of the system comprises:
determining, according to the channel information of the system, the first matrix by using a linear closed-loop precoding technology.

3. The method for linear precoding in a multi-user multiple-input multiple-output system according to claim 2, wherein decomposing the equivalent-channel matrix and obtaining a second matrix through computation comprise:
decomposing an equivalent-channel matrix of an i^{th} user according to H_{eq,i}=QᵢRᵢPᵢ^{H}, so that diagonal elements in the equivalent-channel matrix of the i^{th} user are equal, and obtaining through computation that Fᵢ=Pᵢ, wherein H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}P=I_{L}, wherein L refers to a rank of a channel matrix H, I refers to a unit matrix, and Fᵢ refers to a second matrix of the i^{th} user; and
obtaining F_{b} according to the method for obtaining Fᵢ, wherein F_{b} refers to the second matrix.

4. The method for linear precoding in a multi-user multiple-input multiple-output system according to claim 3, wherein decomposing the equivalent-channel matrix and obtaining a second matrix through computation comprise:
computing a power allocation matrix based on a preset matrix, wherein diagonal elements of matrix blocks corresponding to each user in the preset matrix are diagonal elements in the Rᵢ;
decomposing, based on a preset diagonal matrix, the equivalent-channel matrix of the i^{th} user according to H_{eq, i}=QᵢRᵢPᵢ^{H}, so that diagonal elements in the equivalent-channel matrix of the i^{th} user are equal, and obtaining through computation that Fᵢ=Pᵢ, wherein diagonal elements of the preset diagonal matrix are the same as those of the Rᵢ and G refers to the power allocation matrix; and
obtaining F_{b} according to the method for obtaining Fᵢ, wherein F_{b} refers to the second matrix.

5. The method for linear precoding in a multi-user multiple-input multiple-output system according to claim 4, wherein computing a power allocation matrix based on a preset matrix comprises:
computing the power allocation matrix according to
$$G = {( {\sum }_{e}^{T} {\sum }_{e}^{ } + \frac{{M}_{R} {σ}_{n}^{2}}{{P}_{T}} {I}_{r} )}^{- 1} {\sum }_{e}^{T} ,$$
wherein G refers to the power allocation matrix, Σₑ refers to the preset matrix, P_{T} refers to transmit power allocated to each subcarrier, and Γₙ² refers to noise power of a receiver on each subcarrier bandwidth.

6. The method for linear precoding in a multi-user multiple-input multiple-output system according to claim 1, wherein obtaining a precoding matrix according to the first matrix and the second matrix comprises:
obtaining the precoding matrix according to F=βFₐF_{b}, wherein F refers to the precoding matrix, β refers to a power control factor, Fₐ refers to the first matrix, and F_{b} refers to the second matrix.

7. An apparatus for linear precoding in a multi-user multiple-input multiple-output system, the apparatus comprising:
a determining unit, configured to determine a first matrix according to channel information of the system, wherein the first matrix is used to cancel or suppress multi-user interference;
a first acquiring unit, configured to acquire an equivalent-channel matrix according to the first matrix, wherein the equivalent-channel matrix is used to indicate channel information of the system after interference is canceled;
a computing unit, configured to decompose the equivalent-channel matrix and obtain a second matrix through computation, wherein diagonal elements of matrix blocks corresponding to each user in the second matrix are equal and the second matrix is used to optimize system performance; and
a second acquiring unit, configured to obtain a precoding matrix according to the first matrix and the second matrix, so that a power balance is achieved between spatial streams of each user after at least two signals to be concurrently transmitted are processed by using the precoding matrix.

8. The apparatus for linear precoding in a multi-user multiple-input multiple-output system according to claim 7, wherein the determining unit is configured to: determine, according to the channel information of the system, the first matrix by using a linear closed-loop precoding technology.

9. The apparatus for linear precoding in a multi-user multiple-input multiple-output system according to claim 8, wherein the computing unit comprises:
a first computing module, configured to decompose an equivalent-channel matrix of an i^{th} user according to H_{eq,i}=QᵢRᵢPᵢ^{H}, so that diagonal elements in the equivalent-channel matrix of the i^{th} user are equal, and obtain through computation that Fᵢ=Pᵢ, wherein H_{eq,i} refers to the equivalent-channel matrix of the i^{th} user, Qᵢ refers to a column orthogonal matrix, Rᵢ refers to an upper triangular matrix, Pᵢ refers to a block diagonal matrix, and Q^{H}Q=P^{H}P=I_{L}, wherein L refers to a rank of a channel matrix H, I refers to a unit matrix, and Fᵢ refers to a second matrix of the i^{th} user, and
the first computing module is further configured to obtain F_{b} according to the method for obtaining Fᵢ, wherein F_{b} refers to the second matrix.

10. The apparatus for linear precoding in a multi-user multiple-input multiple-output system according to claim 9, wherein the computing unit comprises:
a second computing module, configured to compute a power allocation matrix based on a preset matrix, wherein diagonal elements of matrix blocks corresponding to each user in the preset matrix are elements in the diagonal matrix Rᵢ; and
a third computing module, configured to decompose, based on a preset diagonal matrix, the equivalent-channel matrix of the i^{th} user according to H_{eq,i}=QᵢRᵢPᵢ^{H}, so that diagonal elements in the equivalent-channel matrix of the i^{th} user are equal, and obtain through computation that Fᵢ=PᵢG, wherein diagonal elements of the preset diagonal matrix are the same as those of the Rᵢ and G refers to the power allocation matrix, and
the third computing module is further configured to obtain F_{b} according to the method for obtaining Fᵢ, wherein F_{b} refers to the second matrix.

11. The apparatus for linear precoding in a multi-user multiple-input multiple-output system according to claim 10, wherein the second computing module is configured to:
compute the power allocation matrix according to
$$G = {( {\sum }_{e}^{T} {\sum }_{e}^{ } + \frac{{M}_{R} {σ}_{n}^{2}}{{P}_{T}} {I}_{r} )}^{- 1} {\sum }_{e}^{T} ,$$
wherein G refers to the power allocation matrix, Σₑ refers to the preset matrix, P_{T} refers to transmit power allocated to each subcarrier, and σₙ² refers to noise power of a receiver on each subcarrier bandwidth.

12. The apparatus for linear precoding in a multi-user multiple-input multiple-output system according to claim 7, wherein the second acquiring unit is configured to:
obtain the precoding matrix according to F=βFₐF_{b}, wherein F refers to the precoding matrix, β refers to a power control factor, Fₐ refers to the first matrix, and F_{b} refers to the second matrix.
